(19) United States
(12) Patent Application Publication
(10) Pub. No.: US 2021/0022317 A1
(43) Pub. Date: Jan. 28, 2021

(54) AUTOMATIC PET FEEDER

(71) Applicant: Jun Ma, Shenzhen, Guangdong (CN)

(72) Inventor: Zilong Ling, Shenzhen, Guangdong (CN)

(21) Appl. No.: 16/644,963

(22) PCT Filed: Sep. 2, 2018
(86) PCT No.: PCT/CN2018/103716

§ 371 Date: Apr. 16, 2020

(30) Foreign Application Priority Data
Sep. 6, 2017 (CN) 201710797074.6
Sep. 6, 2017 (CN) 201710797336.9
Sep. 6, 2017 (CN) 201710797916.8
Oct. 18, 2017 (CN) 201721343011.5

(51) Int. Cl. A01K 5/01; A01K 5/02

(52) U.S. Cl. CPC A01K 5/0114; A01K 5/0291

(57) ABSTRACT

An automatic pet feeder includes a main housing, a food hopper, a food conveyance mechanism, a main control circuit module and a drive motor for the food conveyance mechanism. The food conveyance mechanism is configured to be a toothed conveyor belt, and a conveyor belt passage is provided at a lower part of the food hopper. The toothed conveyor belt passes through a bottom of the food hopper, moves upwards in the food hopper, and turns to move downwards at a level higher than the height of the stored food in the food hopper and above a feeding trough. A cross section of the conveyor belt passage conforms to a projection of the conveyor belt on a plane perpendicular to a running direction of the conveyor belt, and a length of the conveyor belt passage is longer than a length of a conveyor belt segment.

### TECHNICAL FIELD

The present application relates to the field of pet supplies, and particularly to an automatic pet feeder.

### BACKGROUND

Automatic pet feeders, especially programmable automatic pet feeders, are equipment mainly used for daily regular and quantitative feeding, and for providing food to pets regularly and quantitatively according to the program under circumstances that people cannot monitor pets (such as on business trips, or during travels). With this equipment, single or multiple feedings can be achieved every day. Pets can get the right amount of food on time to ensure health, thereby reducing the workload of the pet owner. A more advanced automatic feeder can accommodate more food to provide longer automatic feeding time.

### TECHNICAL PROBLEM

Most of the commercially available automatic feeders use a bladed dial wheel structure. Due to the granular structure of pet food, the rigid dial wheel structure is easy to get stuck and cannot feed, and the soft dial wheel structure has the problem of inaccurate feeding.

### SOLUTION TO THE PROBLEM

### Technical Solution

The technical solution adopted in the present application is:

An automatic pet feeder includes a main housing, a food hopper, a food conveyance mechanism, a main control circuit module, and a drive motor for the food conveyance mechanism. The food conveyance mechanism is configured to be a toothed conveyor belt, and a conveyor belt passage is provided at a lower part of the food hopper, the toothed conveyor belt passing through a bottom of the food hopper, moving upwards in the food hopper, and turning to move downwards at a level higher than the height of the stored food in the food hopper and above a pet food trough. A cross section of the conveyor belt passage conforms to a projection of the conveyor belt on a plane perpendicular to a running direction of the conveyor belt, and a length of the conveyor belt passage is longer than a length of a conveyor belt segment. The toothed conveyor belt is in joint operation with the drive motor for the food conveyance mechanism, the drive motor is in connection with the main control circuit module, and a carrier surface defined by a tooth of the conveyor belt and the conveyor belt is larger than an outer diameter of a pet food particle. In this technical solution, a shape of the conveyor belt that closes the conveyor belt passage once is regarded as a conveyor belt segment. The toothed conveyor belt can be in joint operation with the food drive motor by gear transmission or belt transmission. Specifically, an inner surface of the toothed conveyor belt is provided with grooves. The grooves are engaged with the conveyor belt driving gear, and the conveyor belt driving gear is in joint operation with the drive motor for the food conveyance mechanism through a reduction gear or a reduction belt, or a stepper motor can be used to directly drive the conveyor belt driving gear. In order to fully transport food, the food hopper can be designed as a hopper, the lower opening of the hopper is a conveyor belt passage, and the back of the conveyor belt moves upwards along a side wall of the food hopper. The design is further optimized to seal two ends of each conveyor belt segment of the conveyor belt and two ends of each tooth on the conveyor belt to form upward bucket shapes, at this time, the toothed conveyor belt forms a chain-bucket. The bucket mouths of the conveyor belt are configured to face upwards when moving upwards in the food hopper, and flip down to face downwards when turning to move downwards above the feeding ramp or the feeding trough. All of the above descriptions of the upwards or downwards direction or running direction are all relative to a description of horizontal direction, that is, they include the direction above the horizontal plane larger than 0 degree with the horizontal plane, and vice versa. The main control circuit module, the drive motor, and the mechanical fulcrums of the food conveyance mechanism are fixed on the main housing. Due to manufacturing and modeling design factors, parts of the main housing may be include part or all of the outer wall of food hopper or the feeding ramp. The main control circuit module obtains power supply by connecting the mains or battery. The conveyor belt-typed automatic pet feeder can adopt a common pet feeding trough or a self-contained feeding trough, and the feeding trough is located below the exit of the feeding ramp.

An automatic pet feeder includes a main housing, a food hopper, a food conveyance mechanism, a feeding ramp, a main control circuit module, and a drive motor for the food conveyance mechanism. The food conveyance mechanism is configured to be a toothed conveyor belt, a conveyor belt passage is provided at a lower part of the food hopper, the toothed conveyor belt passing through a bottom of the food hopper, moving upwards in the food hopper, and turning to move downwards at a level higher than the height of the stored food in the food hopper and above the feeding ramp. A cross section of the conveyor belt passage conforms to a projection of the conveyor belt on a plane perpendicular to a running direction of the conveyor belt, and a length of the conveyor belt passage is longer than a length of a conveyor belt segment. The toothed conveyor belt is in joint operation with the drive motor for the food conveyance mechanism, the drive motor is in connection with the main control circuit module, and a carrier surface defined by a tooth of the conveyor belt and the conveyor belt is larger than an outer diameter of a pet food particle. In this technical solution, a shape of the conveyor belt that closes the conveyor belt passage once is regarded as a conveyor belt segment. The toothed conveyor belt can be in joint operation with the food drive motor by gear transmission or belt transmission. Specifically, an inner surface of the toothed conveyor belt is provided with grooves. The grooves are engaged with the conveyor belt driving gear, and the conveyor belt driving gear is in joint operation with the drive motor for the food conveyance mechanism through a reduction gear or a reduction belt, or a stepper motor can be used to directly drive the conveyor belt driving gear. In order to fully transport food, the food hopper can be designed as a hopper, the lower opening of the hopper is a conveyor belt passage, and the back of the conveyor belt moves upwards along a side wall of the food hopper. The design is further optimized to seal two ends of each conveyor belt segment of the conveyor belt and two ends of each tooth on the conveyor belt to form upward bucket shapes, at this time, the toothed conveyor belt forms a chain-bucket. The bucket mouths of the conveyor belt are configured to face upwards when moving upwards in the food hopper, and flip down to face downwards when turning to move downwards above the feeding ramp or the feeding trough. All of the above descriptions of the upwards or downwards direction or running direction are all relative to a description of horizontal direction, that is, they include the direction above the horizontal plane larger than 0 degree with the horizontal plane, and vice versa. The main control circuit board, the drive motor, and the mechanical fulcrums of the food conveyance mechanism are fixed on the main housing. Due to manufacturing and modeling design factors, parts of the main housing may be include part or all of the outer wall of food hopper or the feeding ramp. The main control circuit module obtains power supply by connecting the mains or battery. The conveyor belt-typed automatic pet feeder can adopt a common pet feeding trough or a self-contained feeding trough, and the feeding trough is located below the exit of the feeding ramp.

An automatic pet feeder includes a main housing, a food hopper, a food conveyance mechanism, a feeding ramp, a main control circuit module, and a drive motor for the food conveyance mechanism. The automatic pet feeder further comprises a feeding trough and a pressure sensing member, the feeding trough is provided below an exit of the feeding ramp, the feeding trough is in connection with the main housing through at least three fulcrums, of which at least first and second fulcrums form an approximately horizontal rotating axis, and a third fulcrum is in contact with the pressure sensing member. The pressure sensing member is in connection with the main control circuit, and a bottom of the feeding trough is higher than a bottom support surface of the main housing. The food conveyance mechanism is driven by a drive motor for the food conveyance mechanism to transport pet food from the food hopper to a position above the feeding ramp. The above structure enables the feeding trough to be hung on the main housing, and the weight of the feeding trough is positively correlated with the pressure on the pressure sensor. The main control circuit module can obtain the amount of food in the feeding trough by the analyzing the signal of the pressure sensor, and can further figure out the eating behavior of pets. As pets will constantly touch the feeding trough during the eating process, and food seeking behaviors of the pets can also be figured out according to touching behaviors of the pets when there is no food in the feeding trough.

An automatic pet feeder includes a main housing, a food hopper, a food conveyance mechanism, a feeding ramp, a main control circuit module, and a drive motor for the food conveyance mechanism. The food conveyance mechanism is driven by a drive motor for the food conveyance mechanism to transport pet food from the food hopper to a position above the feeding ramp to throw the pet food. A top of the automatic pet feeder is provided with a hanging rope or a pile configured for tying a hanging rope. Suspending the top of the automatic pet feeder by tying a hanging rope on a fulcrum above the automatic pet feeder is a reliable way to effectively prevent the pet feeder from tipping over. The top of the automatic pet feeder can be equipped with a hanging rope or be provided with a configuration structure configured to tie a hanging rope. The hanging rope does not need to lift the automatic pet feeder, the automatic pet feeder should normally support its own weight by a base, and a length of the hanging rope can be controlled to ensure that the automatic pet feeder do not tip over.

The conveyor belt-typed automatic pet feeder further includes a feeding trough and a pressure sensing member. The feeding trough is provided below an exit of the feeding ramp, the feeding trough is in connection with the main housing through at least three fulcrums, of which at least first and second fulcrums form an approximately horizontal rotating axis, and a third fulcrum is in contact with the pressure sensing member. The pressure sensing member is in connection with the main control circuit, and a bottom of the feeding trough is higher than a bottom support surface of the main housing. The above structure enables the feeding trough to be hung on the main housing, and the weight of the feeding trough is positively correlated with the pressure on the pressure sensor. The main control circuit module can obtain the amount of food in the feeding trough by the analyzing the signal of the pressure sensor, and can further figure out the eating behavior of pets. As pets will constantly touch the feeding trough during the eating process, and food seeking behaviors of the pets can also be figured out according to touching behaviors of the pets when there is no food in the feeding trough.

A food removing brush or a silicone scraper is further provided at a top of the feeding ramp, and an end of the food removing brush or the silicone scraper is in contact with an outer edge of the tooth of the conveyor belt. The brush or the silicone scraper is used to prevent the food particles from sticking to edges of the teeth of the conveyor belt to affect the running of the conveyor belt, and the brush or the silicone scraper can remove the food particles that accidentally stick thereto.

The automatic pet feeder further includes a counting sensor, and a detection area of the counting sensor is configured to be a passing path of the toothed conveyor belt. The counting sensor is configured to be a photoelectric sensor or a magnetic sensor to count the number of segment that the conveyor belt passes. In this way, the amount of food that the conveyor belt has transported can be obtained, that is, counting the amount of food thrown in. Specifically, an infrared geminate-transistor can be used to detect the shielding of the teeth of the conveyor belt for counting, or the metal shafts between the conveyor belt segments can be detected by a metal detection circuit for counting.

The toothed conveyor belt is configured to be a flexible conveyor belt made of silicone or rubber, and an intersegment bending of the flexible conveyor belt is realized by bending its own material. It is easier to reduce the manufacturing complexity by using a one-piece conveyor belt of flexible material, and the elasticity of its own material can avoid jamming.

The main control circuit module further includes a wireless communication circuit module. The wireless communication circuit module can communicate with smart devices or Internet through Bluetooth or WiFi, and can be remotely controlled to set or upload status information.

The automatic pet feeder further includes a camera assembly, and the camera assembly is in connection with the main control circuit module. The camera assembly can be used to take a video of the pet's eating situation. When the main control circuit includes a wireless communication circuit module, the captured image can be wirelessly sent to smart terminal devices such as mobile phones. And microphone parts can be set on the main control circuit module to pick up the scene environment.

The automatic pet feeder further includes a speaker member, and the speaker member is in connection with the main control circuit and is capable of producing sound under control. Voice commands can be issued to the pet through the speaker to help remind the pet to eat.

A top of the automatic pet feeder is provided with a hanging rope or a hanging rope tether loop. Suspending the top of the automatic pet feeder by tying a hanging rope on a fulcrum above the automatic pet feeder is a reliable way to effectively prevent the pet feeder from tipping over. The top of the automatic pet feeder can be equipped with a hanging rope or be provided with a configuration structure configured to tie a hanging rope. The hanging rope does not need to lift the automatic pet feeder, the automatic pet feeder should normally support its own weight by a base, and a length of the hanging rope can be controlled to ensure that the automatic pet feeder do not tip over.

The main control circuit module is a programmable control circuit module with a single-chip microcomputer or ARM as a core. The present application is a programmable automatic device, so the main control circuit module is a programmable control circuit module with a single-chip microcomputer or ARM as the core.

The circuit of the present application may only have a function of simply regular and quantitative feeding such as motor driving and sensing, and may further add interaction and communication to form intelligent hardware for pet products. Corresponding control and communication circuits that are well known to those skilled in intelligent hardware are not described in the description of the present application.

### BENEFICIAL EFFECT OF THE INVENTION

### Beneficial Effect

The central inventive concept of the automatic pet feeder proposed by the present application is to use a conveyor belt-typed structure to always move pet food from the food hopper to a wider direction, so as to avoid the problem of jamming caused by exerting force in a more crowded direction. At the same time, the food load capacity of each conveyor belt segment is relatively stable and consistent. It is easy to finely set the feeding amount. A suspension-fixed type feeding trough and a pressure sensor for supporting the feeding trough are used to realize a closed-loop detection of the feeding amount and a detection of pets' feeding behavior.

### BRIEF DESCRIPTION OF THE DRAWINGS

### Description of the Drawings

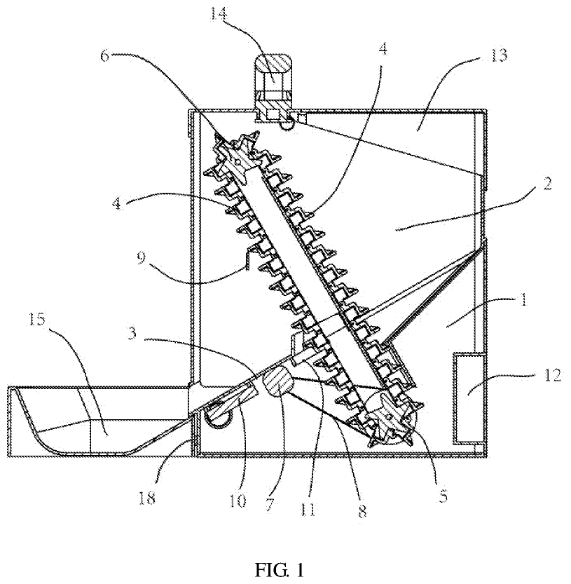

FIG. 1 is a cross-sectional view of an automatic pet feeder according to Embodiment 1.

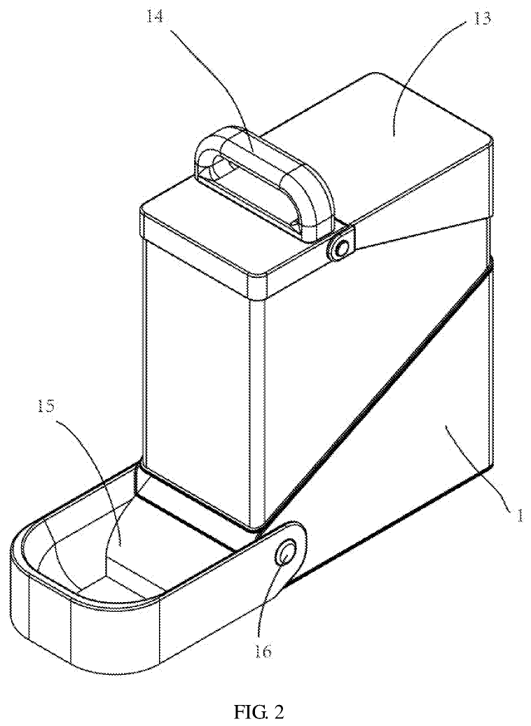

FIG. 2 is a first perspective view of the automatic pet feeder according to Embodiment 1.

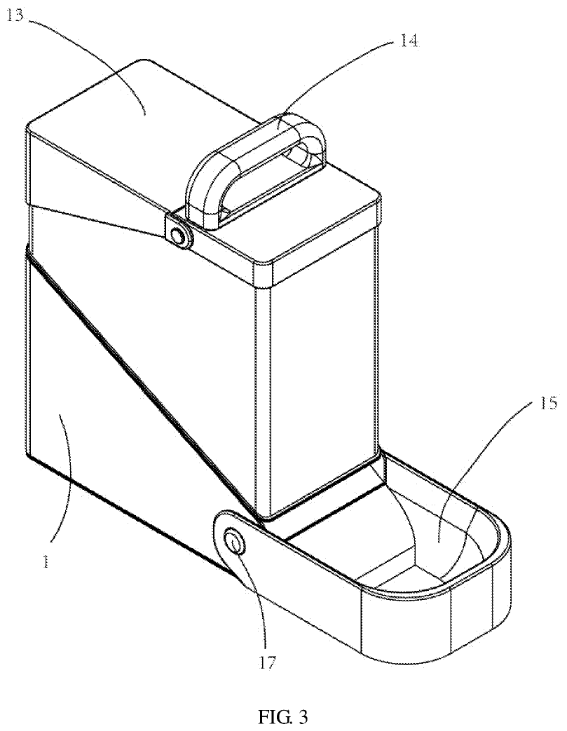

FIG. 3 is a second perspective view of the automatic pet feeder according to Embodiment 1.

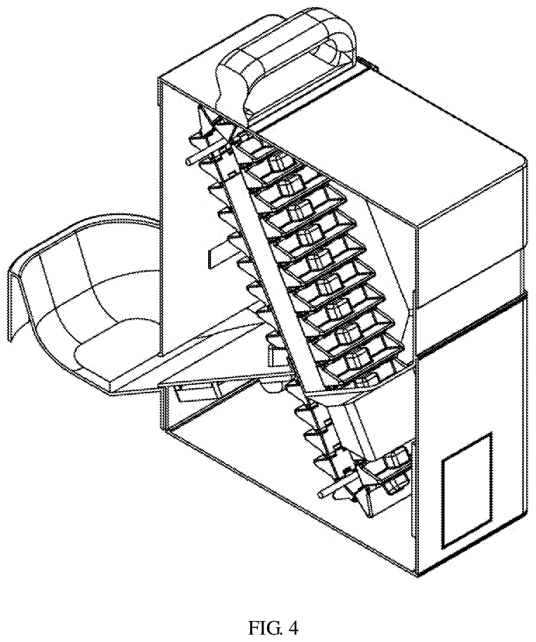

FIG. 4 is a first perspective cross-sectional view of the automatic pet feeder according to Embodiment 1 (no oblique line on the cutting plane).

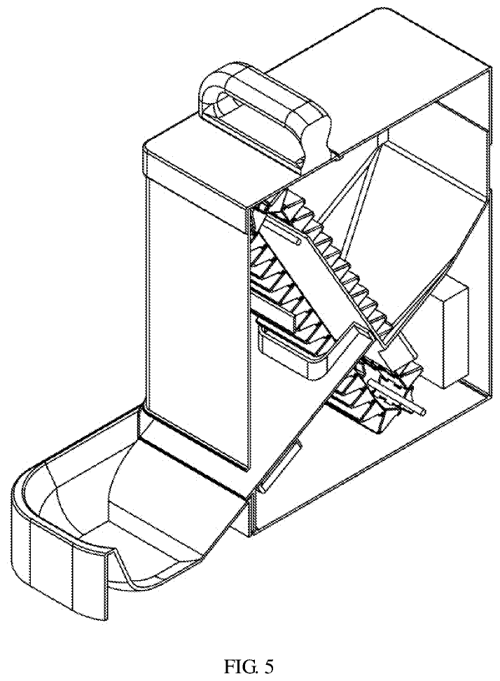

FIG. 5 is a second perspective cross-sectional view of the automatic pet feeder according to Embodiment 1 (no oblique line on the cutting plane).

The meanings of the signs in the figures are as follows: 1 main housing; 2 food hopper; 3 feeding ramp; 4 toothed conveyor belt; 5 conveyor belt driving gear; 6 conveyor belt suspension wheel; 7 motor; 8 drive belt; 9 silicone scraper; 10 main control circuit module; 11 counting sensor; 12 battery compartment; 13 food hopper top cover; 14 handle-typed food hopper top cover lock; 15 feeding trough; 16 first fixed fulcrum of the feeding trough; 17 second fixed fulcrum of the feeding trough; 18 pressure sensor.

### EMBODIMENTS OF THE INVENTION

### Embodiments of the Present Invention

Examples of specific implementations are provided below with reference to the drawings.

Embodiment 1 is shown in FIGS. 1-5, an automatic pet feeder adopts ABS plastic to manufacture the main housing, nylon injection molding to manufacture single segments of the conveyor belt having bucket teeth, and stainless steel shafts to connect conveyor belt segments with one another to form a closed conveyor belt chain. The conveyor belt moves upwards from the hopper-opening shaped conveyor belt passage at the lower part of the food hopper into the food hopper, and slides upwards along a 30-degree inclined sidewall of the food hopper. The back of the conveyor belt is provided with grooves. The lower part of the conveyor belt is fixed on the conveyor belt driving gear, and the upper part of the conveyor belt is fixed on the conveyor belt suspension wheel. The conveyor belt driving wheel is synchronously fixed with a pulley, and a brush motor fixed on the main housing drives the belt through the pulley. The feeding ramp is inclined at an angle of 30 degrees to the horizontal plane. The conveyor belt is turned over at a position of the conveyor belt suspension wheel above the feeding ramp after carrying dog food in the food hopper. The dog food falls freely after the conveyor belt bucket teeth are flipped over and slides into the feeding trough along the feeding ramp. The feeding trough is sleeved on scalable circular buttons on both sides of the main housing through two circular holes, and the feeding trough is supported on a strain gauge pressure sensor. An infrared geminate-transistor counting sensor is set at a position below the feeding ramp where the conveyor belt passing. A silicone scraper is provided at the top of the feeding ramp, when the conveyor belt is running, the minimum distance between the edge of silicone scraper and the edge of the tooth of the conveyor belt is 0.1 mm. The main control circuit module board of this embodiment is fixed to the main control circuit board in the main housing. The main control circuit board is in connection with the motor, the counting sensor and the pressure sensor, at the same time, it is also in connection with the mains and the spare battery compartment. The top of the automatic pet feeder is provided with a rotatable handle. When the handle is rotated over the food hopper top cover, the food hopper top cover can be locked. At the same time, the handle can be used to tie an anti-toppling hanging rope.

1. An automatic pet feeder, comprising: a main housing, a food hopper, a food conveyance mechanism, a main control circuit module, and a drive motor for the food conveyance mechanism,
wherein
the food conveyance mechanism is configured to be a toothed conveyor belt, and a conveyor belt passage is provided at a lower part of the food hopper, the toothed conveyor belt passing through a bottom of the food hopper, moving upwards in the food hopper, and turning to move downwards at a level higher than the height of the stored food in the food hopper and above a feeding trough; a cross section of the conveyor belt passage conforms to a projection of the conveyor belt on a plane perpendicular to a running direction of the conveyor belt, and a length of the conveyor belt passage is longer than a length of a conveyor belt segment; and the toothed conveyor belt is in joint operation with the drive motor for the food conveyance mechanism, the drive motor is in connection with the main control circuit module, and a carrier surface defined by a tooth of the conveyor belt and the conveyor belt is larger than an outer diameter of a pet food particle.

2. An automatic pet feeder, comprising: a main housing, a food hopper, a food conveyance mechanism, a feeding ramp, a main control circuit module, and a drive motor for the food conveyance mechanism,
wherein
the food conveyance mechanism is configured to be a toothed conveyor belt, a conveyor belt passage is provided at a lower part of the food hopper, the toothed conveyor belt passing through a bottom of the food hopper, moving upwards in the food hopper, and turning to move downwards at a level higher than the height of the stored food in the food hopper and above the feeding ramp; a cross section of the conveyor belt passage conforms to a projection of the conveyor belt on a plane perpendicular to a running direction of the conveyor belt, and a length of the conveyor belt passage is longer than a length of a conveyor belt segment; and the toothed conveyor belt is in joint operation with the drive motor for the food conveyance mechanism, the drive motor is in connection with the main control circuit module, and a carrier surface defined by a tooth of the conveyor belt and the conveyor belt is larger than an outer diameter of a pet food particle.

3. An automatic pet feeder, comprising: a main housing, a food hopper, a food conveyance mechanism, a feeding ramp, a main control circuit module, and a drive motor for the food conveyance mechanism,
wherein
the automatic pet feeder further comprises a feeding trough and a pressure sensing member, the feeding trough is provided below an exit of the feeding ramp, the feeding trough is in connection with the main housing through at least three fulcrums, of which at least first and second fulcrums form an approximately horizontal rotating axis, and a third fulcrum is in contact with the pressure sensing member; the pressure sensing member is in connection with a main control circuit, and a bottom of the feeding trough is higher than a bottom support surface of the main housing; and the food conveyance mechanism is driven by a drive motor for the food conveyance mechanism to transport pet food from the food hopper to a position above the feeding ramp.

4. (canceled)

5. The automatic pet feeder according to claim 1, wherein the automatic pet feeder further comprises a feeding trough and a pressure sensing member, the feeding trough is provided below an upper turning area of the conveyor belt or below an exit of the feeding ramp, the feeding trough is in connection with the main housing through at least three fulcrums, of which at least first and second fulcrums form an approximately horizontal rotating axis, and a third fulcrum is in contact with the pressure sensing member; and the pressure sensing member is in connection with a main control circuit, and a bottom of the feeding trough is higher than a bottom support surface of the main housing.

6. The automatic pet feeder according to claim 1, wherein a food removing brush or a silicone scraper is further provided above the feeding ramp, and an end of the food removing brush or the silicone scraper is in contact with an outer edge of the tooth of the conveyor belt.

7. The automatic pet feeder according to claim 1, wherein the automatic pet feeder further comprises a counting sensor, and a detection area of the counting sensor is configured to be a passing path of the toothed conveyor belt.

8. The automatic pet feeder according to claim 1, wherein the toothed conveyor belt is configured to be a flexible conveyor belt made of silicone or rubber, and an intersegment bending of the flexible conveyor belt is realized by bending its own material.

9. The automatic pet feeder according to claim 1, wherein the main control circuit module further comprises a wireless communication circuit module.

10. The automatic pet feeder according to claim 1, wherein the automatic pet feeder further comprises a camera assembly, and the camera assembly is in connection with the main control circuit module.

11. The automatic pet feeder according to claim 1, wherein the automatic pet feeder further comprises a speaker member, and the speaker member is in connection with the main control circuit and is capable of producing sound under control.

12. The automatic pet feeder according to claim 1, wherein a top of the automatic pet feeder is provided with a hanging rope or a hanging rope tether loop.

13. The automatic pet feeder according to claim 2, wherein the automatic pet feeder further comprises a counting sensor, and a detection area of the counting sensor is configured to be a passing path of the toothed conveyor belt.

14. The automatic pet feeder according to claim 2, wherein the toothed conveyor belt is configured to be a flexible conveyor belt made of silicone or rubber, and an intersegment bending of the flexible conveyor belt is realized by bending its own material.

15. The automatic pet feeder according to claim 2, wherein the main control circuit module further comprises a wireless communication circuit module.

16. The automatic pet feeder according to claim 3, wherein the main control circuit module further comprises a wireless communication circuit module.

17. The automatic pet feeder according to claim 2, wherein the automatic pet feeder further comprises a camera assembly, and the camera assembly is in connection with the main control circuit module.

18. The automatic pet feeder according to claim 3, wherein the automatic pet feeder further comprises a camera assembly, and the camera assembly is in connection with the main control circuit module.

19. The automatic pet feeder according to claim 2, wherein the automatic pet feeder further comprises a speaker member, and the speaker member is in connection with the main control circuit and is capable of producing sound under control.

20. The automatic pet feeder according to claim 3, wherein the automatic pet feeder further comprises a speaker member, and the speaker member is in connection with the main control circuit and is capable of producing sound under control.

21. The automatic pet feeder according to claim 2, wherein a top of the automatic pet feeder is provided with a hanging rope or a hanging rope tether loop.
